(19) United States
(12) Patent Application Publication
(10) Pub. No.: US 2026/0257475 A1
(43) Pub. Date: Sep. 3, 2026

(54) LIQUID EJECTION HEAD

(71) Applicant: RISO Technologies Corporation, Tokyo (JP)

(72) Inventor: Hiroyuki WATANABE, Mishima Shizuoka (JP)

(21) Appl. No.: 19/417,269

(22) Filed: Dec. 11, 2025

(30) Foreign Application Priority Data
Mar. 3, 2025 (JP) 2025-033186

(51) Int. Cl. B41J 2/14; B41J 2/20

(52) U.S. Cl. CPC B41J 2/14233; B41J 2/1433; B41J 2/20; B41J 2002/14306; B41J 2002/14419

(57) ABSTRACT

A liquid ejection head includes a nozzle plate formed of a flexible film material and including a plurality of nozzles for ejecting a liquid, and a flow path portion forming a flow path of the liquid that includes: a plurality of pressure chambers respectively communicating with the plurality of nozzles, an individual liquid chamber and a common liquid chamber that communicate with the plurality of pressure chambers. The flow path portion includes a damper portion disposed on a side of the flow path opposite to the nozzle plate, the damper portion being formed of a flexible film material.

### CROSS-REFERENCE TO RELATED APPLICATION

This application is based upon and claims the benefit of priority from Japanese Patent Application No. 2025-033186, filed on March 3, 2025, the entire contents of which are incorporated herein by reference.

### FIELD

Embodiments described herein relate generally to a liquid ejection head.

### BACKGROUND

In a liquid ejection head such as an inkjet head, a common method is used to deform a vibration plate with an actuator made of a piezoelectric material, such as lead zirconate titanate (PZT). This deformation of the vibration plate deforms a pressure chamber facing it, causing ink to be ejected from a nozzle that communicates with the pressure chamber. In such an inkjet head, a vibratable material, such as PI (polyimide), is used for the nozzle plate to have it function as a damper, thereby stabilizing ink ejection during high-speed driving.

### BRIEF DESCRIPTION OF THE DRAWINGS

FIG. 1 is a cross-sectional view illustrating an inkjet head according to a first embodiment.

FIG. 2 is a cross-sectional view illustrating the inkjet head.

FIG. 3 is a diagram illustrating a flow path portion of the inkjet head.

FIG. 4 is a graph illustrating a relationship between a drive frequency and an ejection speed of an inkjet head according to Example 1.

### DETAILED DESCRIPTION

Embodiments of this disclosure provide a liquid ejection head capable of improving ejection performance.

In general, according to one embodiment, a liquid ejection head comprises: a nozzle plate formed of a flexible film material and including a plurality of nozzles for ejecting a liquid; and a flow path portion forming a flow path of the liquid that includes: a plurality of pressure chambers respectively communicating with the plurality of nozzles, an individual liquid chamber and a common liquid chamber that communicate with the plurality of pressure chambers. The flow path portion includes a damper portion disposed on a side of the flow path opposite to the nozzle plate, the damper portion being formed of a flexible film material.

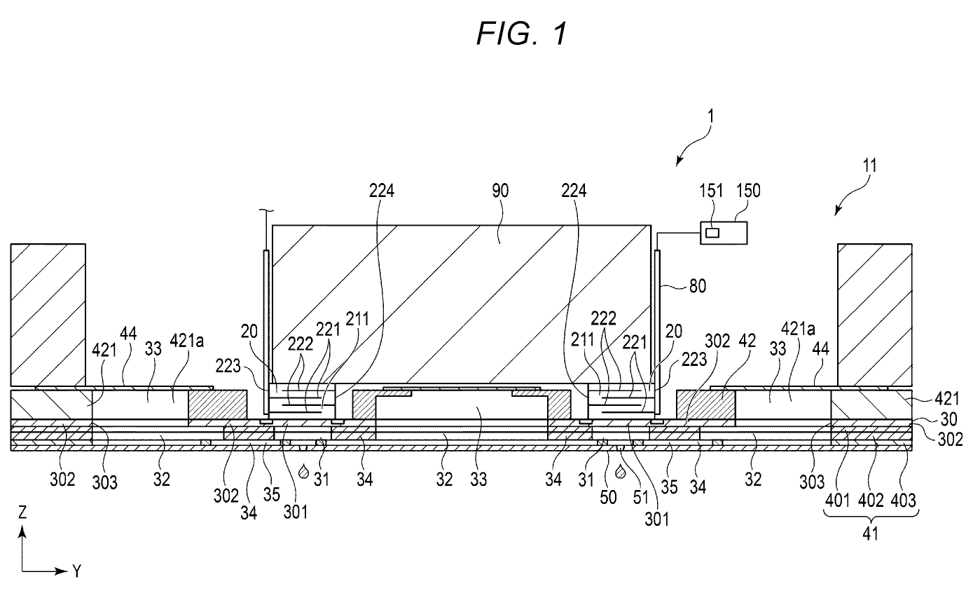

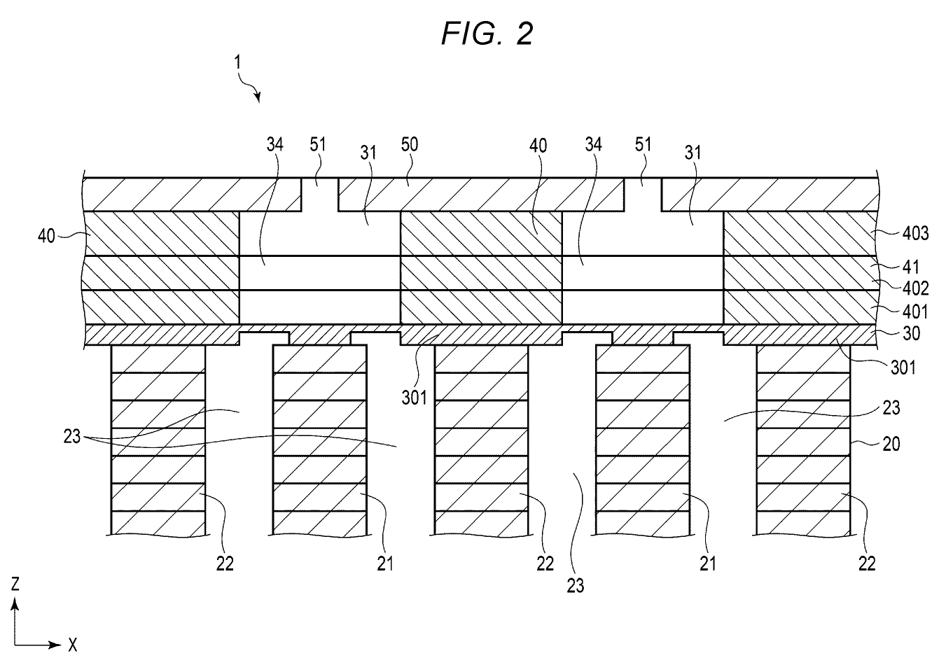

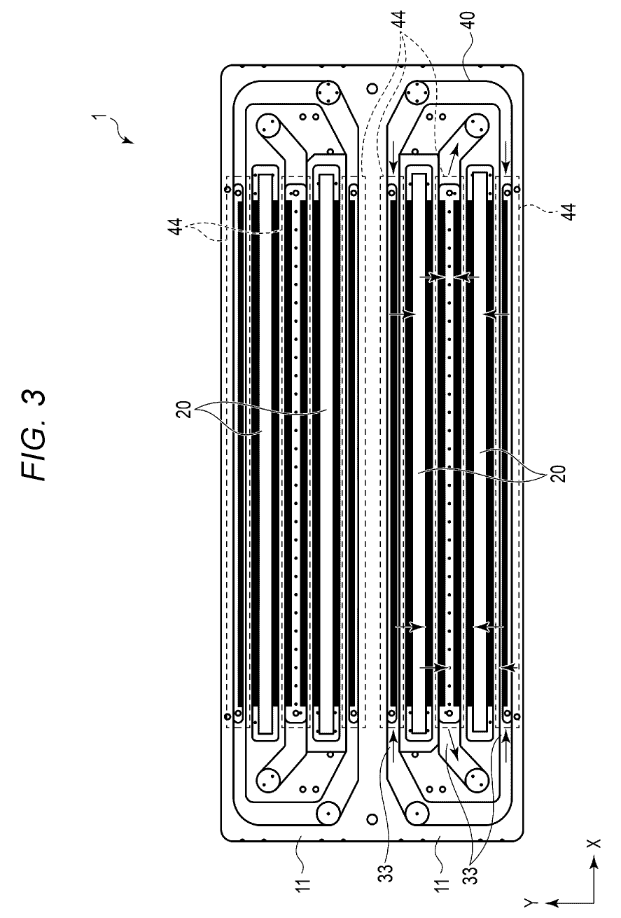

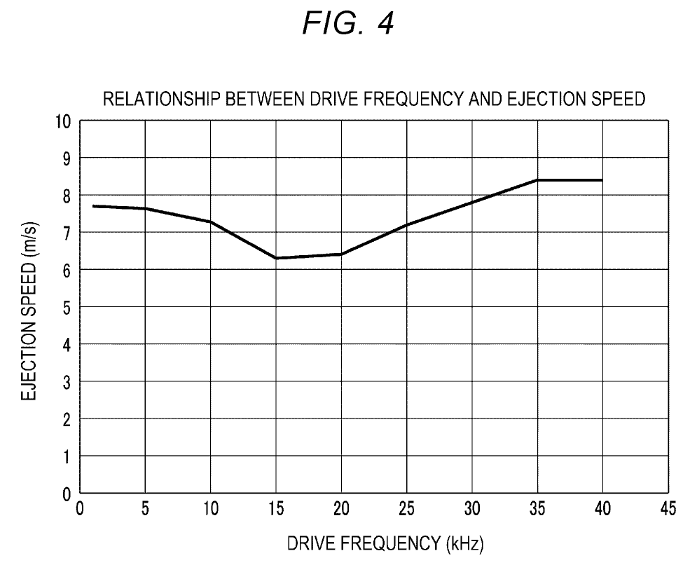

Hereinafter, an inkjet head 1 which is a liquid ejection head according to a first embodiment will be described with reference to FIGS. 1 to 4. FIGS. 1 and 2 are cross-sectional views illustrating the inkjet head 1. FIG. 3 is a diagram illustrating a flow path portion of the inkjet head 1. FIG. 4 is a graph illustrating a relationship between a drive frequency and an ejection speed under conditions of Example 1. In the drawings, arrows X, Y, and Z indicate three directions orthogonal to one another. In the present embodiment, the X direction is the arrangement direction of the nozzles 51 and the pressure chambers 31, the Y direction is the extending direction, and the Z direction is the stacking direction. In the drawings, a configuration is illustrated enlarged, reduced, or omitted as appropriate for the purpose of description.

As illustrated in FIGS. 1 to 3, the inkjet head 1 includes an actuator portion 20, a vibration plate 30, a flow path portion 40 including a plurality of flow path structure portions 41 and 42 and a damper film 44, a nozzle plate 50, and a drive circuit 80.

For example, the inkjet head 1 is implemented by stacking and bonding or laminating the nozzle plate 50, the first flow path structure portion 41, one or more vibration plates 30, the actuator portion 20, the second flow path structure portion 42, and a damper film 44 in this order.

For example, in the inkjet head 1, the vibration direction of a piezoelectric element 21, and the vibration direction of the vibration plate 30 are along the Z direction. In the present embodiment, on a back side of the nozzle plate 50, the vibration plate 30, a plurality of substrates 401, 402, and 403 constituting the first flow path structure portion 41, the second flow path structure portion 42, and the damper film 44 constitute the flow path portion 40 that forms the ink flow path 35 (flow path) in the inkjet head 1. The inkjet head 1 is of a circulation type that causes liquid to circulate in a predetermined flow path. The inkjet head 1 is provided in a liquid ejection apparatus such as an inkjet recording apparatus.

For example, the inkjet head 1 is a four-row integrated head having four rows of actuator portions 20 and four rows of nozzles. In the present embodiment, two vibration plates 30 are disposed to face the first flow path structure portion 41 and the second flow path structure portion 42 which are flow path structure portions. In the inkjet head 1, positions of the nozzles 51 in the four rows of nozzles are shifted to different positions in a parallel direction.

The plurality of actuator portions 20 are formed of, for example, piezoelectric members, and include drive piezoelectric elements 21 (piezoelectric portions) as a plurality of actuators alternately arranged along the row direction and a plurality of non-drive piezoelectric elements 22. In the present embodiment, the nozzle 51 is provided to face the center in an extending direction (Y direction) of the actuator portion 20, and the actuator portion 20 has a structure in which one side and the other side are symmetrical with respect to the nozzle 51. For example, the actuator portion 20 is bonded to a rectangular base 90 serving as a support member. The actuator portion 20 is disposed to face the vibration plate 30 and generates a pressure in the pressure chamber 31.

In the actuator portion 20, the plurality of drive piezoelectric elements 21 and the plurality of non-drive piezoelectric elements 22 are arranged in parallel at regular intervals. For example, the plurality of drive piezoelectric elements 21 and the plurality of non-drive piezoelectric elements 22 are formed in rectangular columnar shapes having the same outer shape. The actuator portion 20 is divided into a plurality of sections by, for example, a plurality of grooves 23, and the plurality of drive piezoelectric elements 21 and the plurality of non-drive piezoelectric elements 22 are arranged in the row direction at the same pitch by, for example, the grooves 23 having the same width.

For example, the plurality of drive piezoelectric elements 21 and the plurality of non-drive piezoelectric elements 22 are formed in a rectangular shape having a short side direction along a row direction of an element row and a longitudinal direction is along an extending direction (Y direction) of the pressure chamber 31 orthogonal to the row direction and the stacking direction (Z direction) in a plan view as viewed from the Z direction which is an axial direction of the nozzle 51.

The drive piezoelectric elements 21 are arranged at positions facing the plurality of pressure chambers 31 formed in the first flow path structure portion 41 in the Z direction. For example, a center position of the drive piezoelectric element 21 in the row direction and the extending direction and a center position of the pressure chamber 31 in the row direction and the extending direction are aligned in the Z direction.

The non-drive piezoelectric elements 22 are arranged at positions facing wall portions formed in the first flow path structure portion 41 in the Z direction. For example, a center position of the non-drive piezoelectric element 22 in the row direction and the extending direction and a center position of the wall portion in the row direction and the extending direction are aligned in the Z direction.

For example, the actuator portion 20 is formed of a stacked piezoelectric member formed by stacking and sintering a sheet-shaped piezoelectric material. In the actuator portion 20, a plurality of piezoelectric elements formed in rectangular columnar shapes are formed at predetermined intervals by forming the grooves 23 by dicing the stacked piezoelectric members from one end surface. Electrodes and the like are provided on a plurality of the formed columnar elements to form the plurality of drive piezoelectric elements 21 and the plurality of non-drive piezoelectric elements 22 that are arranged alternately. The plurality of drive piezoelectric elements 21 and the plurality of non-drive piezoelectric elements 22 are alternately arranged in parallel in a manner of sandwiching the grooves 23 in the row direction.

Each of the drive piezoelectric elements 21 and the non-drive piezoelectric elements 22 includes a plurality of stacked piezoelectric layers 211 and internal electrodes 221 and 222 formed on a surface of each of the piezoelectric layers 211. For example, the drive piezoelectric elements 21 and the non-drive piezoelectric elements 22 have the same stacked structure. Each of the drive piezoelectric elements 21 and the non-drive piezoelectric elements 22 includes external electrodes 223 and 224 formed on surfaces of the piezoelectric element.

The piezoelectric layer 211 is formed of a piezoelectric material such as a lead zirconate titanate (PZT) based material or a lead-free sodium potassium niobate (KNN) based material.

The internal electrodes 221 and 222 are conductive films formed in a predetermined shape and formed of a sinterable conductive material such as silver palladium. The internal electrodes 221 and 222 are connected to the external electrodes 223 and 224 formed on the side surfaces of the piezoelectric elements 21 and 22, respectively.

The external electrodes 223 and 224 are formed on surfaces of the plurality of drive piezoelectric elements 21 and the plurality of non-drive piezoelectric elements 22, and are formed by collecting end portions of the internal electrodes 221 and 222.

In the present embodiment, for example, the external electrodes 223 are individual electrodes, and the external electrodes 224 are common electrodes. Each of the external electrodes 223 and 224 is connected to a control unit 150 via a driver IC of the drive circuit 80, and is implemented to be driven and controlled. The arrangement of the common electrode and the individual electrode may be reversed.

The drive piezoelectric element 21 vibrates when a voltage is applied to the internal electrodes 221 and 222 via the external electrodes 223 and 224. In the present embodiment, the drive piezoelectric elements 21 perform longitudinal vibration along the stacking direction of the piezoelectric layers 211. Here, the term "longitudinal vibration" refers to, for example, "vibration in a thickness direction defined by a piezoelectric constant d33". The drive piezoelectric element 21 displaces the vibration plate 30 and deforms the pressure chamber 31 by the longitudinal vibration. That is, the actuator portion 20 is disposed to face the vibration plate 30 and generates a pressure in the pressure chamber 31.

The vibration plate 30 extends along a plane orthogonal to the Z direction, which is a vibration direction, and is bonded to one side in the stacking direction, which is the vibration direction of the piezoelectric layers 211 of the plurality of piezoelectric elements 21 and 22, that is, a surface on a side close to the nozzle plate 50. The vibration plate 30 faces the plurality of nozzles 51 via the pressure chambers 31 in the Z direction which is the vibration direction. For example, the vibration plate 30 is implemented to be deformable. The vibration plate 30 is bonded to the drive piezoelectric element 21 and the non-drive piezoelectric element 22 of the actuator portion 20.

In the inkjet head 1 according to the present embodiment, two vibration plates 30 are provided for the four rows of actuator portions 20. That is, two rows of actuator portions 20 are provided for each of the vibration plates 30.

For example, the vibration plate 30 is disposed to overlap the other side of the first flow path structure portion 41 in the stacking direction, and forms a part of the ink flow path 35. For example, the vibration plate 30 has a vibration region 301 facing the actuator portion 20 and a support region 302 bonded to the first flow path structure portion 41 and the second flow path structure portion 42. For example, the vibration region 301 forms a wall on a side opposite to an ejection side of the pressure chamber 31 in a facing direction.

The vibration region 301 of the vibration plate 30 forms a part of the pressure chamber 31 of the ink flow path 35. In addition, the support region 302 of the vibration plate 30 is disposed to overlap and be bonded between the first flow path structure portion 41 and the second flow path structure portion 42 in the stacking direction.

The vibration region 301 has, for example, a flat plate shape disposed such that the thickness direction is the vibration direction of the piezoelectric layer 211. A plane direction of the vibration plate 30 extends in the arrangement direction of the plurality of drive piezoelectric elements 21 and the plurality of non-drive piezoelectric elements 22. The vibration plate 30 is, for example, a metal plate.

For example, the vibration plate 30 is formed of a nickel plate or an SUS plate, and a thickness dimension along the vibration direction is about 5 μm to 15 μm, and is formed to be, for example, 10 μm in the present embodiment. The vibration region 301 is deformed by displacing a portion that faces the drive piezoelectric element 21 due to expansion and compression of the drive piezoelectric element 21. For example, since the vibration plate 30 needs to have a very thin and complicated shape, the vibration plate 30 is formed by electroforming or the like. The vibration plate 30 is bonded to the upper end surface of the actuator portion 20 by adhesion or the like. In the vibration region 301, a fold or a step may be formed at a portion adjacent to the vibration portion or between adjacent vibration portions so that the plurality of vibration portions are easily displaced.

The support region 302 is disposed to face the first flow path structure portion 41 and the second flow path structure portion 42 in the stacking direction. In addition, the vibration plate 30 may be partially opened to form a flow path through which a first common liquid chamber 32 and a second common liquid chamber 33 communicate with each other. For example, the vibration plate 30 has an opening 303 through which the first common liquid chamber 32 and the second common liquid chamber 33 communicate with each other.

The flow path portion 40 includes the first flow path structure portion 41, the second flow path structure portion 42, and the damper film 44 which is a damper portion. The flow path portion 40 is stacked and assembled together with the nozzle plate 50 and the vibration plate 30 to form the ink flow path 35 including the pressure chamber 31 communicating with the nozzle 51, a connection flow path 34 which is an individual flow path, the first common liquid chamber 32, and the second common liquid chamber 33. Specifically, the first flow path structure portion 41, the vibration plate 30, the second flow path structure portion 42, and the damper film 44 are assembled to the nozzle plate 50 in this order in the stacking direction.

The first flow path structure portion 41 includes the plurality of flow path substrates 401, 402, and 403. The first flow path structure portion 41 is bonded to one side of the vibration plate 30, and forms the plurality of pressure chambers 31 and the first common liquid chamber 32.

The first flow path structure portion 41 may be formed of an integrated member or may be formed of a plurality of flow path substrates to be stacked. For example, the plurality of flow path substrates 401, 402, and 403, the nozzle plate 50, and the vibration plate 30, each of which has an opening or a groove, are combined and bonded to form the desired ink flow path 35 according to ink viscosity, a volume of the ink to be ejected, and the like. The plurality of flow path substrates 401, 402, and 403 are disposed to overlap each other in the stacking direction, and the predetermined ink flow path 35 including the connection flow path 34 and the pressure chamber 31 is formed by openings or grooves formed in each of the flow path substrates 401, 402, and 403. For example, the flow path substrates 401, 402, and 403 are stacked in order from the vibration plate 30 side, the flow path substrate 401 is disposed to face the vibration plate, and the flow path substrate 403 is disposed to face the nozzle plate 50.

The first flow path structure portion 41 is disposed between the nozzle plate 50 and the vibration plate 30. The first flow path structure portion 41 forms the plurality of pressure chambers 31, the plurality of connection flow paths 34, and the first common liquid chamber 32 therein by stacking and bonding a plurality of flow path substrates to each other. In other words, the first flow path structure portion 41 is a partition wall portion that separates the plurality of pressure chambers 31 and the plurality of connection flow paths 34 and a peripheral wall portion that surrounds an outer periphery of the ink flow path 35 by the plurality of flow path substrates that are stacked.

As illustrated in FIGS. 1 and 2, the first flow path structure portion 41 is disposed to face the vibration plate 30 in the stacking direction and is bonded to the vibration plate 30. The first flow path structure portion 41 includes the plurality of flow path substrates 401, 402, and 403, and each of the flow path substrates 401, 402, and 403 is formed of, for example, a metal material including SUS 430 or a resin material such as silicone. Openings constituting the pressure chamber 31, the connection flow path 34, and the first common liquid chamber 32 are formed in the flow path substrates 401, 402, and 403, respectively. As an example, an opening forming the pressure chamber 31 and the first common liquid chamber 32 is formed in the flow path substrate 401 and the flow path substrate 402, and an opening forming the pressure chamber 31, the connection flow path 34, and the first common liquid chamber 32 is formed in the flow path substrate 403.

That is, in the first flow path structure portion 41, the plurality of pressure chambers 31, the connection flow path 34, and the first common liquid chamber 32 are formed by the openings of the plurality of flow path substrates 401, 402, and 403 that communicate with one another and are arranged in the stacking direction.

The plurality of pressure chambers 31 are formed on one side of the vibration region 301 of the vibration plate 30, and each of the pressure chambers 31 communicates with the nozzle 51 formed in the nozzle plate 50. The pressure chambers 31 are covered by the vibration plate 30 on a side opposite to the nozzle plate 50.

The plurality of pressure chambers 31 communicate with the first common liquid chamber 32 via the connection flow path 34. The pressure chamber 31 stores and holds a liquid supplied through the first common liquid chamber 32 and the connection flow path 34, and ejects the liquid from the nozzle 51 by being deformed by the vibration of the vibration plate 30 forming a part of the pressure chamber 31.

The first common liquid chamber 32 is a flow path communicating with end portions of the plurality of connection flow paths 34 in a flow direction. For example, the first common liquid chamber 32 is formed on both sides of the row of the pressure chambers 31 by the first flow path structure portion 41. The first common liquid chamber 32 extends in the X direction and communicates with the plurality of rows of connection flow paths 34. For example, a plurality of rows of the first common liquid chambers 32 are formed, and each of the first common liquid chambers 32 extends along a parallel direction (X direction) of the nozzles 51 orthogonal to or intersecting the extending direction (Y direction) in which the connection flow path 34 and the pressure chamber 31 are arranged. As an example, in the present embodiment, as illustrated in FIG. 3, in head main body portions for two rows, one of the first common liquid chambers 32 for ejection is formed between the pair of actuator portions 20, and the first common liquid chambers 32 for supply are formed on both side portions of a pair of the actuator portions 20. That is, in the entire head having the four-row structure, four first common liquid chambers 32 for supply and two first common liquid chambers 32 for ejection are formed, and the damper films 44 are provided on the other side in the stacking direction with respect to the six common liquid chambers 32 and the common liquid chamber 33 communicating with the six common liquid chambers 32.

The connection flow path 34 communicates with the pressure chambers 31 and the first common liquid chambers 32, and extends in the Y direction, which is the flow direction. The connection flow paths 34 on both sides are formed to have a smaller dimension in the width direction orthogonal to the extending direction which is the flow direction and a smaller thickness than the first common liquid chamber 32 and the pressure chamber 31, and are formed to have a narrower flow path cross section.

A partition wall portion that separates the plurality of pressure chambers 31 and the plurality of connection flow paths 34 from each other and a peripheral wall portion that surrounds the outer periphery of the ink flow path 35 are formed by portions other than the openings of the flow path substrates 401, 402, and 403.

The second flow path structure portion 42 is disposed on an outer peripheral portion of the actuator portion 20. The second flow path structure portion 42 includes a frame-shaped frame portion 421 that is disposed on an outer peripheral portion of the vibration plate 30 and is bonded to the first flow path structure portion 41. For example, the second flow path structure portion 42 is a plate-shaped member formed of a metal material such as SUS and having a thickness of 0.6 mm to 1.2 mm, and may constitute a part of an outer shell of the inkjet head 1. The second flow path structure portion 42 forms a liquid flow path therein. For example, the frame portion 421 of the second flow path structure portion 42 has a flow path hole 421a forming the second common liquid chamber 33 communicating with the first common liquid chamber 32 of the first flow path structure portion 41. For example, the flow path hole 421a is a recess that forms the second common liquid chamber 33.

The second common liquid chamber 33 communicates with the first common liquid chamber 32 formed in the first flow path structure portion 41. The common liquid chamber 33 is formed inside the frame portion 421 and communicates with the pressure chamber 31 through the first common liquid chamber 32 and the connection flow path 34.

The damper film 44 is a flexible film member and is formed of a resin material such as a polyimide (PI). The damper film 44 is disposed to face the nozzle plate 50 via at least one of the common liquid chambers formed on both sides. As an example, the damper film 44 is disposed to face the second flow path structure portion 42 on a side opposite to the vibration plate 30. For example, the damper film 44 covers an opening of the second flow path structure portion 42 formed by the flow path hole 421a constituting the common liquid chamber 33. The damper film 44 is thinner than the nozzle plate 50.

For example, in the two rows of head main body portions 11 illustrated in FIGS. 1 and 3, the damper films 44 are provided at three locations in total, two common liquid chambers 33 on the supply side and one common liquid chamber 33 on the ejection side. That is, the damper films 44 are provided at positions facing the nozzle plate 50 with the two common liquid chambers 33 and the common liquid chamber 33 on the ejection side interposed therebetween. Specifically, the damper film 44 adheres to an edge portion of the flow path hole 421a forming the common liquid chamber 33 of the frame portion 421.

In the ejection-side common liquid chamber 33 formed between the pair of actuator portions 20, a base 90 is disposed on one side of the damper film 44, but for example, the damper film 44 is not bonded to the base 90, a gap is formed between the damper film 44 and the base 90, allowing the damper film 44 to be supported in a deformable manner. That is, one surface of the damper film 44 faces the common liquid chamber 33, and the other main surface of the damper film 44 is not in contact with other members, and a space in which deformation can be secured is formed.

The nozzle plate 50 is formed of a resin material such as polyimide, and has a rectangular plate shape with a thickness of about 10 μm to 100 μm. For example, the nozzle plate 50 is formed of a flexible film material having a damper function. The nozzle plate 50 is disposed on one side of the first flow path structure portion 41 to cover an opening on one side of the pressure chamber 31. The nozzle plate 50 has a plurality of nozzles 51 that eject liquid droplets. The plurality of nozzles 51 are holes that pass through the nozzle plate 50 in the thickness direction. The plurality of nozzles 51 are arranged in the first direction the same as the arrangement direction of the pressure chambers 31 to form a nozzle row. The nozzles 51 are provided at positions corresponding to the plurality of pressure chambers 31, respectively.

The drive circuit 80 includes a wiring film having one end connected to the external electrodes 223 and 224, a driver IC mounted on the wiring film, and a printed wiring board mounted on the other end of the wiring film.

The drive circuit 80 causes the driver IC to drive the piezoelectric element 21 by applying a drive voltage to the external electrodes 223 and 224 to increase or decrease a volume of the pressure chamber 31, and causes droplets to be ejected from the nozzle 51.

The wiring film is connected to the plurality of external electrodes 223 and 224. For example, the wiring film is an anisotropic conductive film (ACF) fixed to connection portions with the external electrodes 223 and 224 by thermo-compression bonding or the like. The wiring film is, for example, a chip on film (COF) on which the driver IC is mounted.

The driver IC is connected to the external electrodes 223 and 224 via a wiring film. Instead of the wiring film, the driver IC may be connected to the external electrodes 223 and 224 by other methods such as an anisotropic conductive paste (ACP), a non-conductive film (NCF), and a non-conductive paste (NCP).

The driver IC generates a control signal and a drive signal for operating each piezoelectric element 21. The driver IC generates a control signal for controlling a timing of ejecting ink and selection of the piezoelectric element 21 to eject ink according to an image signal received from the control unit 150 of the inkjet recording apparatus. The driver IC generates a voltage to be applied to the piezoelectric element 21, that is, a drive signal, according to the control signal. When the driver IC applies the drive signal to the piezoelectric element 21, the piezoelectric element 21 is driven to displace the vibration plate 30 and change the volume of the pressure chamber 31. Accordingly, the ink filled in the pressure chamber 31 is caused to perform pressure vibration. Due to the pressure vibration, the ink is ejected from the nozzle 51 provided in the pressure chamber 31. The inkjet head 1 may be implemented to achieve gradation expression by changing an amount of ink droplets that land on one pixel. The inkjet head 1 may be implemented to change the amount of ink droplets that land on one pixel by changing the number of times of ink ejection. In this manner, the driver IC is an example of an application unit that applies a drive signal to the piezoelectric element 21.

For example, the driver IC includes a data buffer, a decoder, and a driver. The data buffer stores printing data in time series for each piezoelectric element 21. The decoder controls the driver based on the printing data stored in the data buffer for each piezoelectric element 21. The driver outputs a drive signal for operating each piezoelectric element 21 based on the control of the decoder. The drive signal is, for example, a voltage to be applied to each piezoelectric element 21.

The printed wiring board includes a printing wiring assembly (PWA) mounted with various electronic components and connectors. The printed wiring board is connected to the control unit 150 of the inkjet recording apparatus.

The control unit 150 includes a control circuit 151 or controller including a central processing unit (CPU), a read only memory (ROM) that stores various programs, a random access memory (RAM) that temporarily stores various kinds of variable data, image data, and the like, and an interface circuit that receives data from the outside and outputs data to the outside. For example, the control unit 150 may be mounted on the liquid ejection apparatus side on which the inkjet head 1 is provided.

When the flow path structure portion is assembled in the inkjet head 1 implemented as described above, the nozzle plate 50, the flow path substrates 401, 402, and 403 constituting the first flow path structure portion 41, the vibration plate 30, the second flow path structure portion 42, and the damper film 44 are stacked, an adhesive is applied to a predetermined adhesion region including an outer peripheral portion between the respective members, and the members are stacked and pressurized to constitute the flow path structure portion. Then, the actuator portion 20 in a state of being bonded to the base 90 is disposed in the opening formed in the flow path structure portion, and is bonded to the vibration plate 30 to face the vibration plate 30, thereby assembling the actuator portion 20 to the flow path structure portion.

In the inkjet head 1, the first flow path structure portion 41 and the second flow path structure portion 42 are bonded via an adhesive.

When the nozzle plate 50, the flow path substrates 401, 402, and 403 constituting the first flow path structure portion 41, the vibration plate 30, and the second flow path structure portion 42 are stacked by supplying the adhesive to the adhesion region between members stacked on each other and pressed in the stacking direction, the plurality of members 50, 401, 402, 403, 30, 421, and 44 adhere to each other via the adhesive. For example, the adhesion region is set in an outer edge portion outside a pressure chamber forming region or between regions where the plurality of pressure chamber rows are arranged.

As described above, on the back side of the nozzle plate 50, the vibration plate 30, the first flow path structure portion 41, the second flow path structure portion 42, and the damper film 44 constitute a flow path structure portion that forms the ink flow path 35 (flow path portion) in the inkjet head 1. The ink flow path 35 includes the plurality of pressure chambers 31 disposed at positions corresponding to the stacking direction of the drive piezoelectric elements 21 of the actuator with the vibration plate 30 interposed therebetween, the connection flow paths 34 disposed on both sides in the extending direction of the plurality of pressure chambers 31, the first common liquid chambers 32 continuous with the end portions of the plurality of connection flow paths 34 on both sides in the extending direction and extending in the X direction, and the second common liquid chamber 33 formed by the second flow path structure portion 42 and the damper film 44.

The inkjet head 1 is a circulation type, and for example, the first common liquid chamber 32 communicates with an ink tank, and the ink is supplied to each of the pressure chambers 31 through the first common liquid chamber 32 on an inflow side. All of the piezoelectric elements 21 are connected so that a voltage can be applied to the wiring. In the inkjet head 1, when the control unit 150 causes a driver IC to apply a drive voltage to the electrodes 221 and 222, the piezoelectric element 21 to be driven vibrates in the stacking direction, that is, the thickness direction of the piezoelectric layers 211. That is, the piezoelectric element 21 vibrates longitudinally.

Specifically, the control unit 150 selectively drives the piezoelectric element 21 to be driven by applying a drive voltage to the internal electrodes 221 and 222 of the piezoelectric element 21 to be driven. Then, the vibration plate 30 is deformed and the volume of the pressure chamber 31 is changed by the piezoelectric element 21 to be driven by combining deformation in a tensile direction and deformation in a compression direction, thereby guiding the liquid from the first common liquid chamber 32 and ejecting the liquid from the nozzle 51.

The ink supplied to the pressure chamber 31 is ejected from the nozzle 51, passes through the connection flow path 34 on the other side serving as a collection side and the common liquid chambers 32 and 33, and is collected in the ink tank.

In the inkjet head 1, the ink circulates in the ink flow path 35 with one side in the extending direction as an inflow side (supply side) and the other side as an outflow side (collection side).

Here, a driving operation for driving the inkjet head 1 will be described. The inkjet head 1 according to the present embodiment includes the piezoelectric elements 21 disposed in a manner of facing the pressure chambers 31, and the piezoelectric elements 21 are connected by wiring so that a voltage can be applied thereto. The control unit 150 sends a drive signal to the driver IC according to the image signal corresponding to the image data, and applies a drive voltage to the internal electrodes 221 and 222 of the piezoelectric element 21 to be driven, thereby selectively deforming the piezoelectric element 21 to be driven. The liquid is ejected by changing the volume of the pressure chamber 31 by combining the deformation of the vibration plate 30 in the tensile direction and the deformation of the vibration plate 30 in the compression direction.

For example, the control unit 150 alternately performs a pulling operation and a compressing operation. In the inkjet head 1, at the time of pulling for increasing an internal volume of the target pressure chamber 31, the piezoelectric element 21 to be driven is contracted, and a drive piezoelectric element other than a drive target is not deformed. In the inkjet head 1, at the time of compressing for reducing the internal volume of the target pressure chamber 31, the target drive piezoelectric element 21 is extended and the non-drive piezoelectric element 22 is not deformed.

According to the inkjet head 1 in the above-described embodiment, since the nozzle plate and the flow path portion constituting a part of the common flow path portion are formed of the flexible film, it is possible to appropriately adjust a damper effect, and it is possible to perform ejection with low viscosity and high speed driving.

For example, in order to control the damper effect only by a nozzle plate, it is necessary to change the thickness of the film or to increase the area, and it is difficult to secure the ejection performance. That is, when the thickness is reduced, a nozzle length is also reduced, and when the area is increased, a nozzle surface is increased, so that the size is increased, and the possibility of damage during maintenance such as wiping is increased.

In contrast, in the above-described embodiment, not only the nozzle plate but also a part of the flow path portion 40 forming the common liquid chamber is formed of PI, and thus it is possible to improve the damper effect. In addition, since the damper film is used in the flow path portion facing the nozzle plate 50 in the flow path portion 40, a high-performance damper can be provided with a simple configuration. When the viscosity of the ink decreases, it is necessary to weaken the action of the damper, and it is also possible to perform adjustment so that the action of the damper is weakened by attenuating the ink by using PI as the structure portion facing the nozzle plate of the flow path portion, and it is possible to appropriately adjust the action of the damper by combination with the nozzle plate. In addition, the area of the common liquid chamber can be reduced by the configuration of the damper film on a facing surface side, and a width of the head can also be reduced.

FIG. 4 is a graph illustrating the drive frequency and the ejection speed in the case of single nozzle drive (one nozzle) and in the case of simultaneous drive (multiple nozzles) in which adjacent nozzles are simultaneously driven in the inkjet head 1 in the present embodiment. Conditions of Example 1 in FIG. 4 are an ink viscosity of 5 mPas, a frequency of 1 kHz, and a voltage of 15 pL. Based on FIG. 4, it can be seen that up to 40 kHz can be ejected under the conditions of Example 1.

The present disclosure is not limited to the embodiment described above, and the elements described above can be modified and embodied in an implementation stage without departing from the gist of the disclosure.

For example, in the above-described embodiment, four rows of the actuator portions 20 and the pressure chambers 31 are arranged, but embodiments of the present disclosure are not limited thereto. For example, the nozzles 51 and the pressure chambers 31 may be arranged in three or less rows or five or more rows. In addition, in the first embodiment, two vibration plates 30 are provided in each of two rows for the four rows of actuator portions 20, but embodiments of the present disclosure are not limited thereto.

For example, the specific configuration of the first flow path structure portion 41 is not limited to the above. For example, the flow path substrate may be formed of one member, or may be formed of two or four or more members. In addition, shapes of openings in the flow path substrates are not limited to those in the above-described embodiment.

For example, the piezoelectric element 21 formed by stacking a plurality of piezoelectric members is driven by longitudinal vibration (d33) in the stacking direction in the above-described embodiment, the embodiment disclosed herein is not limited thereto. For example, the piezoelectric element 21 may be applicable to an aspect of being formed of a single-layer piezoelectric member, and may be applicable to an aspect of being driven by lateral vibration (d31).

Specific configurations of the piezoelectric elements 21 and 22, shapes of flow paths, and configurations and positional relationships of various components including the first flow path structure portion 41, the nozzle plate 50, and the second flow path structure portion 42 are not limited to examples described above, and can be appropriately changed. The arrangement of the nozzles 51 and the arrangement of the pressure chambers 31 are not limited to those described above. For example, the nozzles 51 may be arranged in two or more rows. Dummy chambers may be formed between the plurality of pressure chambers 31.

The liquid to be ejected is not limited to ink for printing, and for example, the embodiment described herein may be applied to an apparatus that ejects a liquid containing conductive particles for forming a wiring pattern of a printed wiring board.

Although the inkjet head 1 is used in a liquid ejection apparatus such as an inkjet recording apparatus in the embodiment described above, the embodiment described herein is not limited thereto. For example, the inkjet head 1 may be used in a 3D printer, an industrial manufacturing machine, and a medical application, and the inkjet head 1 can be reduced in size, weight, and cost.

According to at least one embodiment described above, it is possible to improve the ejection performance.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A liquid ejection head comprising:
a nozzle plate formed of a flexible film material and including a plurality of nozzles for ejecting a liquid; and
a flow path portion forming a flow path of the liquid that includes:
a plurality of pressure chambers respectively communicating with the plurality of nozzles,
an individual liquid chamber and a common liquid chamber that communicate with the plurality of pressure chambers, wherein
the flow path portion includes a damper portion disposed on a side of the flow path opposite to the nozzle plate, the damper portion being formed of a flexible film material.

2. The liquid ejection head according to claim 1, wherein
the film material of the damper portion is thinner than the film material of the nozzle plate.

3. The liquid ejection head according to claim 1, wherein
the film material of each of the damper portion and the nozzle plate contains a polyimide.

4. The liquid ejection head according to claim 1, further comprising:
a vibration plate disposed on a side of the pressure chamber opposite to the nozzle plate; and
an actuator disposed on a side of the vibration plate opposite to the pressure chamber.

5. The liquid ejection head according to claim 1, wherein
the flow path further includes a plurality of connection flow paths connected to one side and the other side of the pressure chambers in a first direction, the common liquid chamber communicating with the plurality of connection flow paths.

6. The liquid ejection head according to claim 5, wherein
the common liquid chamber extends along a second direction intersecting the first direction and is between the damper portion and the nozzle plate.

7. The liquid ejection head according to claim 1, wherein
the flow path portion further includes:
a first flow path structure portion that forms part of the plurality of pressure chambers and the common liquid chamber, and
a second flow path structure portion connected to the first flow path structure portion.

8. The liquid ejection head according to claim 7, wherein
the second flow path structure portion includes a frame portion having an opening that forms part of the common liquid chamber, and
the damper portion covers the opening of the frame portion.

9. The liquid ejection head according to claim 7, wherein
the damper portion has a first surface facing the common liquid chamber and a second surface opposite the first surface and not contacting any other parts of the liquid ejection head.

10. The liquid ejection head according to claim 7, further comprising:
a vibration plate disposed on a side of the pressure chamber opposite to the nozzle plate; and
an actuator disposed on a side of the vibration plate opposite to the pressure chamber, wherein
the nozzle plate, the first flow path structure portion, the vibration plate, the actuator, the second flow path structure portion, and the damper portion are stacked in this order.

11. The liquid ejection head according to claim 10, wherein
the second flow path structure portion is disposed on an outer peripheral portion of the actuator.

12. The liquid ejection head according to claim 10, wherein
the actuator includes a plurality of drive piezoelectric elements and a plurality of non-drive piezoelectric elements that are arranged alternately.

13. The liquid ejection head according to claim 10, wherein
the plurality of nozzles are arranged in a plurality of rows, and
the actuator includes a plurality of actuator portions corresponding to the plurality of rows of nozzles.

14. The liquid ejection head according to claim 7, wherein
the first flow path structure portion includes a plurality of stacked flow path substrates that form the plurality of pressure chambers and the common liquid chamber.

15. The liquid ejection head according to claim 1, wherein
the liquid ejection head is a circulation-type head in which the liquid circulates through the flow path.
